(19) United States
(12) Patent Application Publication
(10) Pub. No.: US 2011/0088531 A1
(43) Pub. Date: Apr. 21, 2011

(54) Guitar support

(76) Inventors: John Colin Woodland, (US); Adrian Woodland, (US)

(21) Appl. No.: 12/924,093

(22) Filed: Sep. 20, 2010

(30) Foreign Application Priority Data
Sep. 18, 2009 (GB) 09 16 435.1

(51) Int. Cl. G10G 5/00

(52) U.S. Cl. 84/327

(57) ABSTRACT

Two guitar storage supports have L-shapes. A first support is rigid, and a second support is resilient. A first arm of the first support attaches to a surface. The second arm of the first support is connected to a guitar strap peg. A first arm of the second resilient support is adjustably connected to the surface. The second arm of the resilient support is flexed to receive a second strap peg on the guitar. The resilient second support is released to resiliently return to its L-shape, thereby attaching the second peg to the second support.

The present invention relates to a guitar support for supporting a guitar having a body and a neck extending from said body, a first strap peg towards the rear of the body of the guitar and a second strap peg towards the front of the body of the guitar.

The present invention also relates to a method of storing and/or displaying a guitar.

Apparatus for supporting guitars are known. In particular, it is known to support guitars by means of their headstock in which a substantially U-shaped member is attached to a wall or similar support such that the guitar may be supported in a substantially vertical orientation. However, a problem with such guitar supports is that they are somewhat limited in terms of the particular orientation in which the guitar may be placed. Furthermore, by supporting a guitar from its headstock, stresses will be applied to the neck of the guitar which may in turn lead to the introduction of distortions. Furthermore, it is also possible for the substantially U-shaped member to damage the lacquer finish of the guitar which may in turn require the guitar to be varnished again.

According to an aspect of the present invention, there is a guitar support provided for supporting a guitar having a body and a neck extending from said body, a first strap peg towards the rear of the body of the guitar and a second strap peg towards the front of the body of the guitar. The guitar support comprises a first substantially L-shaped member having rigidity and a second substantially L-shaped member showing resilience, wherein the first substantially L-shaped member has a first arm which is configured to secure the substantially first L-shaped member to a surface. The first substantially L-shaped member also has a first support hole in a second arm for rigidly supporting the first strap peg of the guitar. The second substantially L-shaped member has a third arm configured to secure the second substantially L-shaped member to the surface and the second substantially L-shaped member has a second support hole in a fourth arm for resiliently supporting the second strap peg of the guitar, such that the guitar is supported by the rigidity of the first L-shaped member and is allowed to be inserted into and removed from said members by the resilience of the second L-shaped member. The fourth arm of the second substantially L-shaped member is flexed by application of manual pressure so as to allow the second strap peg to be received, and then the second strap peg is located into the second support hole of the second substantially L-shaped member by releasing the manual pressure so as to allow the fourth arm to resiliently return to its unstressed condition.

The invention will now be described, by way of example only, with reference to the accompanying drawings, in which

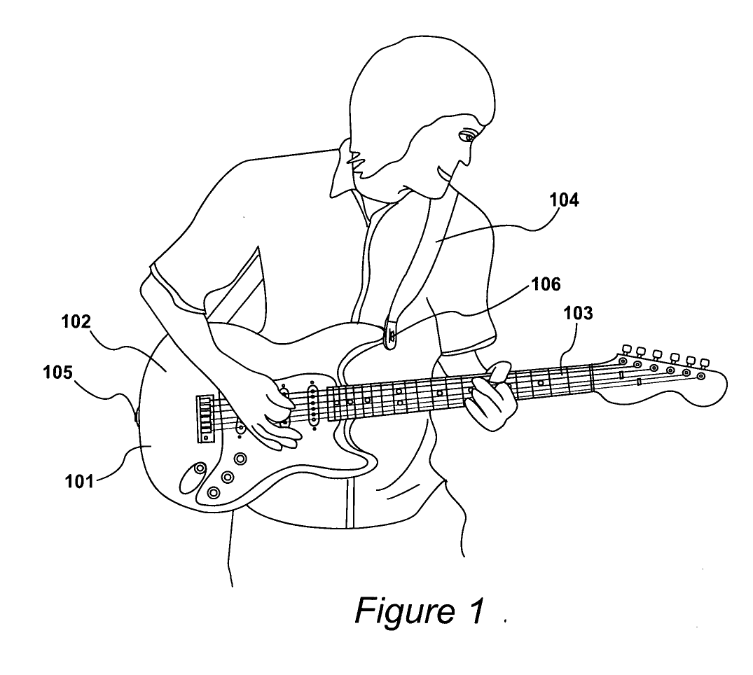

FIG. 1 shows an electric guitar having a body portion and a neck;

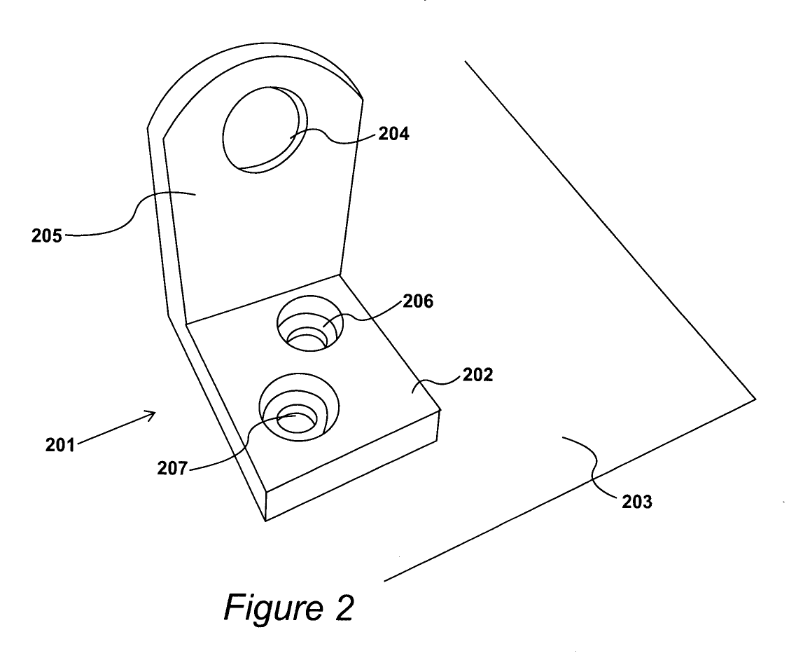

FIG. 2 shows an L-shaped device for supporting the first strap peg of the electric guitar in FIG. 1;

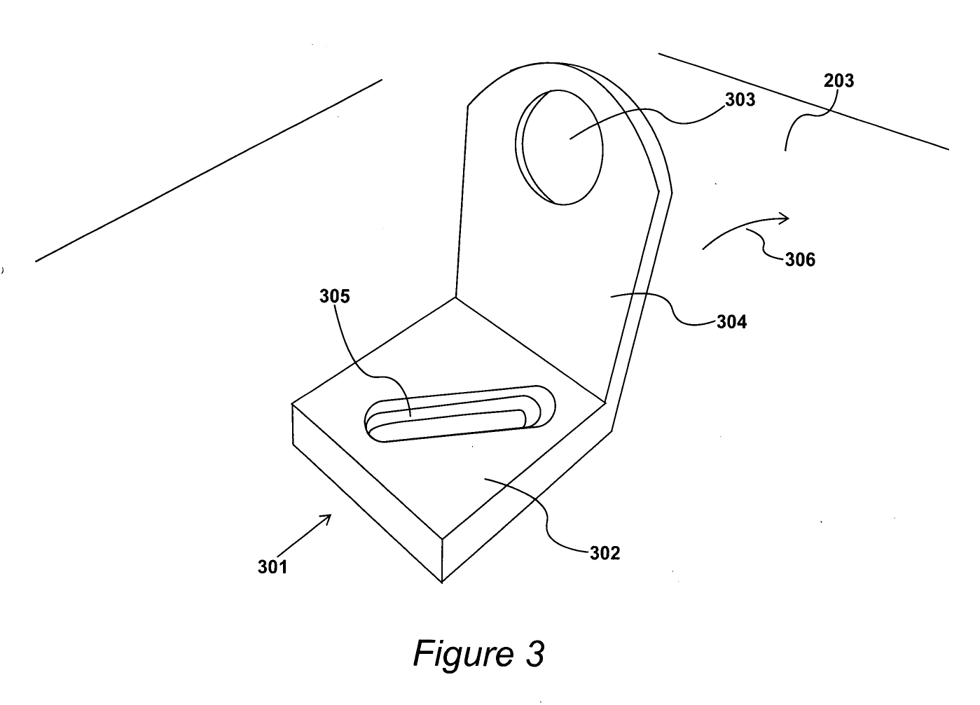

FIG. 3 shows a second L-shaped device for supporting the second strap peg of the electric guitar in FIG. 1;

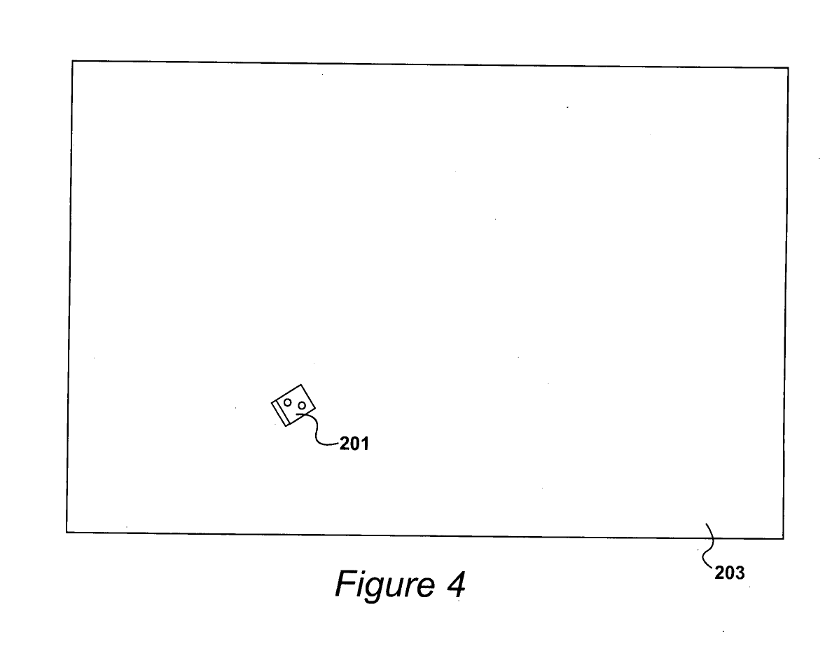

FIG. 4 shows the L-shaped device from FIG. 2 assembled onto an appropriate surface;

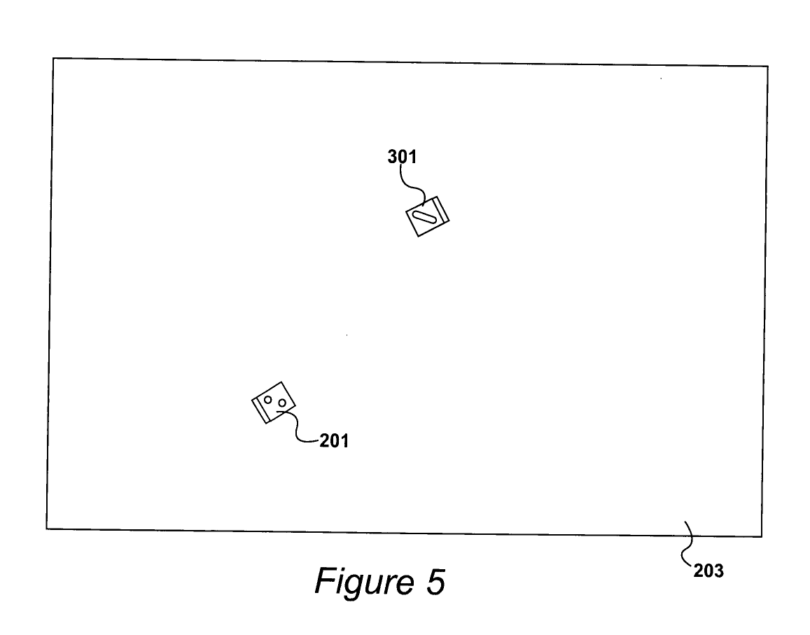

FIG. 5 shows both L-shaped devices from FIGS. 2 and 3 secured onto an appropriate surface;

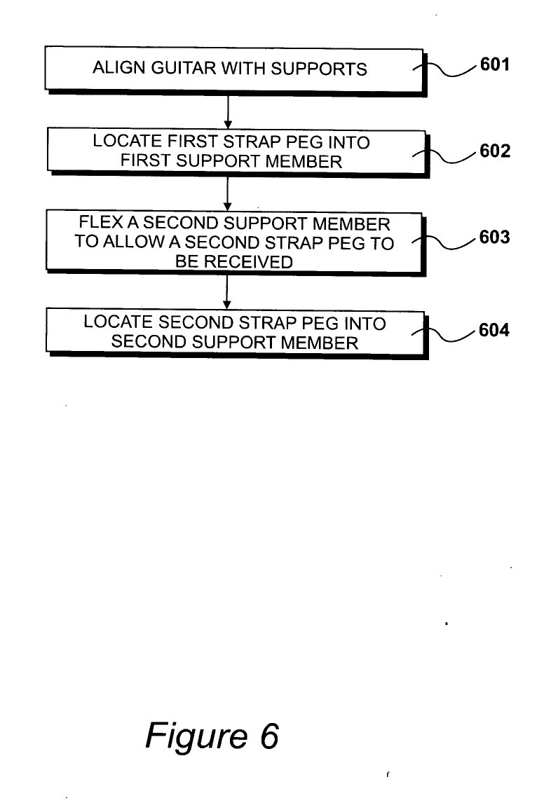

FIG. 6 shows a method of storing and/or displaying an electric guitar;

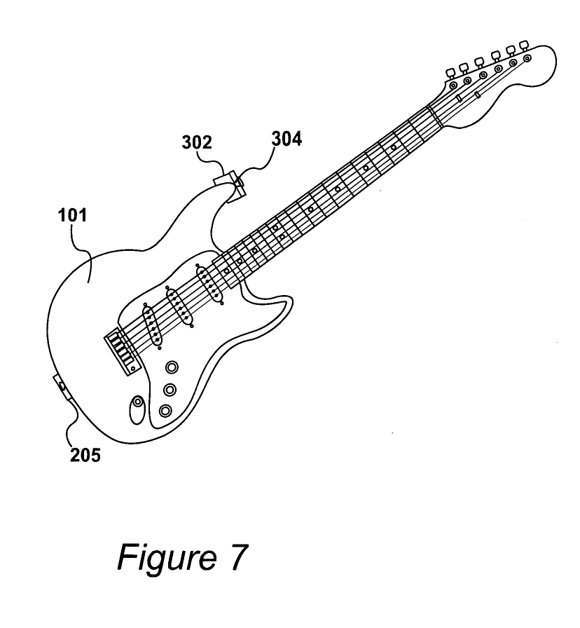

FIG. 7 shows a supported guitar using the devices illustrated in FIGS. 2 and 3;

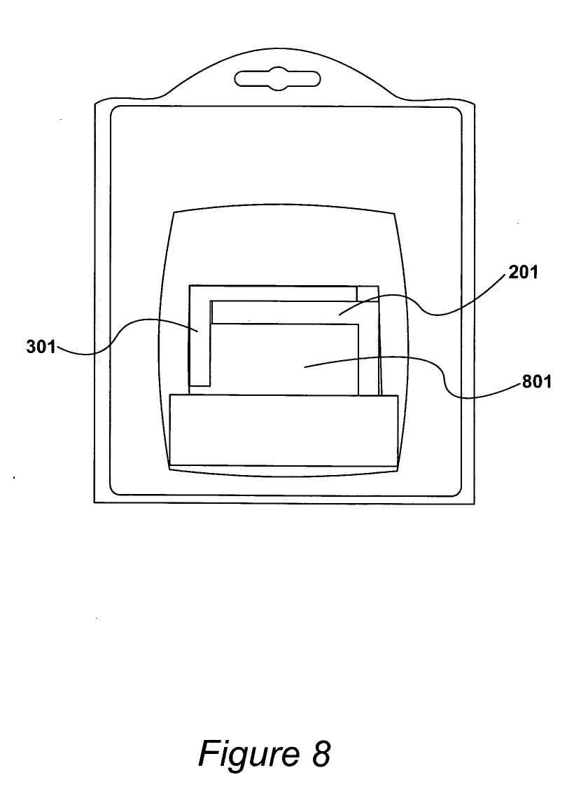

FIG. 8 shows a packaging and distribution solution for the L-shaped devices

### DETAILED DESCRIPTION OF THE INVENTION

### FIG. 1

An electric guitar 101 is shown in FIG. 1 having a body portion 102 and a neck 103. When being played, the guitar 101 may be supported by a strap 104. Strap 104 connects with a first strap peg 105 towards the rear of the body 102 of the guitar and a second strap peg 106 extending from the front of the body of the guitar. The inventor has appreciated that, in addition to being used to support the guitar while being played, strap pegs 105 and 106 could be used to support the guitar while it is being stored;

### FIG. 2

A device for supporting the guitar of the type shown in FIG. 1 is illustrated in FIG. 2 and FIG. 3. The device has a first substantially L-shaped member 201 and a second substantially L-shaped member 301 (as shown in FIG. 3).

The first substantially L-shaped member 201, as shown in FIG. 2, has a first arm 202 configured to secure the substantially L-shaped member 201 to a surface 203. The L-shaped member 201 also has a first porthole 204 in a second arm 205 for rigidly supporting the first strap peg 105 of a guitar, such as guitar 101.

### FIG. 3

The second substantially L-shaped member 301 (as shown in FIG. 3) has a third arm 302 configured to secure the L-shaped member 301 to surface 203. The second L-shaped member 301 also has a second support hole 303 in a fourth arm 304 for resiliently supporting the second strap peg 106 of the guitar 101.

In use, the guitar 101 is supported by the rigidity of the first L-shaped member 201 and is allowed to be inserted into and removed from the members 201/203 by the resilience of the second L-shaped member 301.

It is possible for the L-shaped members 201 and 301 to be fabricated from many materials including plastics and metals provided that the required level of rigidity is provided by the first member 201 and the required level of resilience is provided by the second member 301. However, in a preferred embodiment, the L-shaped members are fabricated from a substantially transparent material. Again, many materials are available that provide the preferred degree of transparency but in a preferred embodiment the L-shaped members 201/301 are fabricated from polycarbonate.

Many means of attachment are available for attaching the L-shaped members 201/301 to an appropriate surface, usually a wall, but an attachment could also be made to a ceiling. In a preferred embodiment, the first arm 202 is configured to secure the first substantially L-shaped member 201 by the provision of a plurality of holes and in the example shown in FIG. 2, arm 202 is provided with a first hole 206 and a second hole 207. The L-shaped member 201 may then be secured to a surface by the provision of appropriate screws or bolts, preferably provided as a kit of parts illustrated in FIG. 8.

Preferably, the third arm 302 is configured to secure the second substantially L-shaped member by the provisional slot 305, again arranged to receive a securing screw as previously described in reference to FIG. 2. Thus, in this way, during assembly, the first L-shaped member 201 is secured to surface 203 at a specific position so as to provide rigid support for the first strap peg of the guitar. The second L-shaped member may be positioned and secured by a screw and then a fine adjustment may be made by sliding slot 305 about the secured screw (not shown).

In the example shown in FIGS. 2 and 3, the L-shaped members are substantially solid and smooth. However, in an alternative embodiment, the L-shaped members are provided with a plurality of ribs so as to reduce material content while maintaining the required levels of rigidity and strength.

### FIG. 4

The supports shown in FIGS. 2 and 3 are assembled on to surface 203 in order to support guitar 101.

The first substantially L-shaped member 201 is secured to surface 203 by the provision of the first arm 202. Once secured, as shown in FIG. 4, the second arm 205 is rigid so that it may support the first strap peg 105.

### FIG. 5

Having rigidly secured the first support 201, the second substantially L-shaped member 301 is secured to surface 203. The second substantially L-shaped member 301 has a third arm 302 configured to secure the second substantially L-shaped member 301 to the surface 203. In addition, the fourth arm 304 resiliently supports the second strap peg 106.

As previously described, the first arm has a plurality of holes and a first substantially L-shaped member is secured by fixing the screws which extend through said holes 206 and 207 into the surface 203, such as a wall. The second substantially L-shaped member is secured by a screw which extends through slot 305.

Slot 305 is provided so that it is possible to loosely attach the second L-shaped member to surface 203 whereafter it is possible to locate a guitar in the second L-shaped member 201. The position of the second substantially L-shaped member may then be adjusted while the guitar is in place, whereafter the guitar is removed and the second L-shaped member is then securely attached at the optimised position.

### FIG. 6

A method of storing and/or displaying guitar 101 is illustrated in FIG. 6. At step 601 the guitar is aligned with the supports, possibly by lifting guitar 101 to an appropriate level.

At step 602 a first strap peg 105 is located into hole 204 of the first support member 201.

At step 603 the second support member 301 is flexed so as to allow the second strap peg 106 to be received. In particular, the fourth arm 304 is forced (by the application of manual pressure) in the direction of arrow 306, as shown in FIG. 3.

Thereafter, as illustrated at step 604, the second strap peg is located into hole 303 of the second support member 301 by releasing the said manual pressure so as to allow arm 304 to resiliently return to its unstressed condition.

### FIG. 7

A supported guitar as illustrated in FIG. 7. In this preferred configuration, the arms that are attached to surface 203 are substantially obscured by the presence of the stored guitar itself. Thus, the second arm 205 extends from the wall but the restraining arm 202 is totally obscured by the body of the guitar 101.

Similarly, arm 304 extends from surface 203 but much of the restraining arm 302 is obscured by the guitar. Furthermore, when fabricated from transparent material, the effect is to provide what appears to be a “floating” guitar.

### FIG. 8

It can be appreciated that the L-shaped members are relatively small, compared to known devices for supporting guitars. This provides an advantage in terms of packaging and distribution, as illustrated in FIG. 8.

To facilitate distribution, the first substantially L-shaped member 201 and the second substantially L-shaped member 301 fit together as shown in FIG. 8 and in addition provide a void 801 for appropriate fixing devices, such as screws that co-operate with holes 206 and 207 and slot 305.

1. A guitar support for supporting a guitar having a body and a neck extending from said body, a first strap peg towards the rear of the body of the guitar and a second strap peg towards the front of the body of the guitar, comprising a first substantially L-shaped member having rigidity and a second substantially L-shaped member showing resilience, wherein:
said first substantially L-shaped member has a first arm configured to secure the substantially first L-shaped member to a surface;
said first substantially L-shaped member has a first support hole in a second arm for rigidly supporting the first strap peg of a guitar;
said second substantially L-shaped member has a third arm configured to secure the second substantially L-shaped member to said surface; and
said second substantially L-shaped member has a second support hole in a fourth arm for resiliently supporting the second strap peg of said guitar, wherein said fourth arm of the second substantially L-shaped member is flexed by application of manual pressure so as to allow the second strap peg to be received, and further wherein said second strap peg is located into said second support hole of said second substantially L-shaped member by releasing said manual pressure so as to allow said fourth arm to resiliently return to its unstressed condition.
such that the guitar is supported by the rigidity of the first L-shaped member and is allowed to be inserted into and removed from said members by the resilience of the second L-shaped member.

2. The guitar support of claim 1, wherein said first substantially L-shaped member and said second substantially L-shaped member are fabricated from a substantially transparent material.

3. The guitar support of claim 1, wherein said first substantially L-shaped member and said second substantially L-shaped member are fabricated from polycarbonate.

4. The guitar support of claim 1, wherein said first arm is configured to secure the first substantially L-shaped member by the provision of a plurality of holes, each arranged to receive a securing screw.

5. The guitar support of claim 1, wherein said third arm is configured to secure the second substantially L-shaped member by the provision of a slot arranged to receive a securing screw.

6. The guitar support of claim 1, wherein said first substantially L shaped member and said second substantially L-shaped member include a plurality of ribs.

7. A method of storing and/or displaying a guitar having a body and a neck extending from said body, a first strap peg towards the rear of the body of the guitar and a second strap peg towards the front of the body of the guitar comprising the steps of:
locating said first strap peg into a first hole defined by a substantially rigid first support member attached to a surface; and
locating said second strap peg into a second hole defined by a substantially resilient second support member attached to said surface, in which said second substantially resilient second support member flexes under manual pressure so as to allow the second strap peg to be received within said second hole and resiliently returns to its unstressed condition upon releasing said manual pressure.

8. The method of claim 7, wherein said support members are substantially L-shaped, in which a first or third arm is attached to a surface and a second or fourth arm defines said first or second hole.

9. The method of claim 8 wherein:
said first strap peg is located into a first support hole in a second arm defined by a substantially rigid first L-shaped member attached to a surface; and
a second strap peg is located into a second support hole in a fourth arm defined by a substantially resilient second L-shaped member attached to said surface, in which said second substantially resilient second L-shaped member flexes under application of manual pressure so as to allow the second strap peg to be received and resiliently returns to its unstressed condition upon releasing said manual pressure.

10. The method of claim 7, wherein said attachment to a surface is obscured by the presence of the stored guitar.

11. The method of claim 9, wherein the substantially L-shaped members are substantially transparent so as to minimise the visual presence of the supporting members.

12. The method of claim 7, wherein the guitar is removed by applying pressure upon the resilient second support member and sliding the second strap peg out of the second hole.
